(19) United States
(12) Patent Application Publication
(10) Pub. No.: US 2008/0030315 A1
(43) Pub. Date: Feb. 7, 2008

(54) TIRE CONDITION MONITORING SYSTEM

(75) Inventors: Eiji Hirose, Kanagawa (JP); Toshimitsu Ebinuma, Kanagawa (JP)

Correspondence Address: KNOBBE MARTENS OLSON & BEAR LLP, 2040 MAIN STREET, FOURTEENTH FLOOR, IRVINE, CA, 92614, US

(73) Assignee: The Yokohama Rubber Co., Ltd., Tokyo (JP)

(21) Appl. No.: 11/831,845

(22) Filed: Jul. 31, 2007

(30) Foreign Application Priority Data
Aug. 2, 2006 (JP) 2006-210781

(51) Int. Cl. B60C 23/00

(52) U.S. Cl. 340/447

(57) ABSTRACT

A tire condition monitoring system, having antennas attached onto each of both right and left side ends of a vehicle windshield, the antennas being connected to a monitoring unit installed near a driver's seat, by which installation on the monitoring unit side can be easily achieved. This enables positive reception of electric waves transmitted from the sensor device by either of the antennas of the right and left side portions of the windshield, thus permitting the monitoring unit to achieve a desired high receiving probability. Accordingly, the tire condition monitoring system provides easy installation without need of attaching any receiving antenna of the monitoring unit at a position adaptable to the sensor device of each tire, as well as attainment of a desired receiving probability at the monitoring unit.

### CROSS-REFERENCE TO RELATED APPLICATIONS

This application claims the benefit and priority to Japanese Application Number 2006-210781 filed on Aug. 2, 2006. The disclosure of the above-described application is hereby incorporated by reference in its entirety.

### BACKGROUND OF THE INVENTION

1. Field of the Invention

The present invention relates to tire condition monitoring systems that monitor the physical quantity of a tire and, in particular, to a tire condition monitoring system that can be easily applied to medium- and large-sized vehicles.

2. Description of the Related Art

For safe driving of vehicles, conventionally, inspection of physical conditions of tires such as tire air pressures was essential. However, manual inspection of tires requires much manpower and time. Accordingly, various types of tire condition monitoring systems for automatically detecting physical conditions of tires such as air pressures had been developed and have become widespread to ordinary vehicles.

The typical tire condition monitoring system is composed of sensor devices which are generally mounted on tires, detect physical conditions of tires and wirelessly transmit the detection results, and a monitoring unit which receives data transmitted from the sensors.

Each of the sensors is generally mounted on the inside of each of the tires and, in many cases, is fixed on a tire rim or embedded into the tire.

A tire condition monitoring system for compact vehicles can receive electric waves from all tires 2 with a receiving antenna 11, which is connected with a monitoring unit 10 and is attached onto a windshield 4 of a vehicle 1, as shown in FIG. 29.

On the other hand, use of the tire condition monitoring system for compact vehicles as a tire condition monitoring system for medium- and large-sized vehicles would increase a distance between a sensor 20 mounted on each tire 2 and a receiving antenna 11 mounted on a windshield 4 and enlarge attenuation of an electric wave, and hence a sufficient receiving probability cannot be achieved only by the one receiving antenna 11 mounted on a windshield 4. Accordingly, a present typical tire condition monitoring system for medium- and large-sized vehicles establishes itself as a system by disposing a receiving antenna 11 near a sensor 20 as shown in FIG. 30. As this type of tire condition monitoring system with a plurality of receiving antennas 11, there are known systems disclosed, for example, in Japanese Patent Publication Nos. 2003-300452, 2005-254927 and 2006-21746.

However, in conventional tire condition monitoring systems for medium- and large-sized vehicles, each of the plurality of receiving antennas 11 must be disposed near the tire 2 mounted with sensor 20. Accordingly, each antenna must be disposed at each tire house, which causes the following problems: routing of a coaxial cable for connecting the monitoring unit 10 with the receiving antenna 11 requires much time and effort, resulting in a cost increase.

### SUMMARY OF THE INVENTION

In view of the aforementioned problems, it is an object of the present invention to provide a tire condition monitoring system that can be easily installed without need of disposing a receiving antenna for a monitoring unit at a position adapted to a sensor position of each tire and can achieve a desired receiving probability in the monitoring unit.

To attain the aforementioned object, according to the present invention, a tire condition monitoring system comprises: a plurality of sensor devices, at least one being mounted on each of all tires of a vehicle, each having a sensor detecting the physical quantity of the tire and transmitting detection results from the sensor to the outside of the tire by an electric wave; a monitoring unit receiving electric waves from the plurality of sensor devices and acquiring the detection results from the sensor for each of the sensor devices; an antenna disposed on each window glass of right and left side portions of the vehicle, connected to the monitoring unit and receiving electric waves transmitted from the respective sensor devices.

Moreover, the monitoring unit of the tire condition monitoring system according to the present invention comprises: a plurality of receiving sections disposed for each antenna; a central processing unit which inputs received signals output from each of the plurality of receiving sections and acquires detection results from the received signals for each of the sensor devices; and at least one delay section which delays, on the basis of received signals output from a predetermined one receiving section, output signals from the other receiving sections by different periods, respectively and inputs the signals into the central processing unit.

The tire condition monitoring system according to the present invention is disposed with an antenna on each window glass of right and left side portions of a vehicle, by which electric waves transmitted from the sensor devices mounted on respective tires are received by either of the antennas at the right and left side portions. Moreover, the delay section delays, on the basis of received signals output from one receiving section, output signals from the other receiving section by different periods, respectively and inputs the signals into the central processing unit and, even if electric waves are received at a same time by the respective antennas, the received signals of electric waves are not input into the central processing unit at the same time. This enables easy installation on the monitoring unit side and positive reception of electric waves transmitted from the sensor device by either of the antennas of the right and left side portions of a vehicle, thus permitting the monitoring unit to achieve a desired receiving probability.

### BRIEF DESCRIPTION OF THE DRAWINGS

FIG. 1 is an external perspective view showing a vehicle equipped with a tire condition monitoring system according to one embodiment of the present invention;

FIG. 2 is a horizontal view showing the tire condition monitoring system according to one embodiment of the present invention;

FIG. 3 is a view showing a mounting state of a sensor device according to one embodiment of the present invention;

FIG. 4 is a view describing a positional relationship between a loop antenna of the sensor device and a tire wheel according to one embodiment of the present invention;

FIG. 5 is a block diagram showing an electric circuit of the sensor device according to one embodiment of the present invention;

FIG. 6 is a block diagram showing an electric circuit of a monitoring unit according to one embodiment of the present invention;

FIG. 7 is a timing chart describing operation of a delay circuit according to one embodiment of the present invention;

FIG. 8 is a configuration view showing an antenna of the monitoring unit according to one embodiment of the present invention;

FIG. 9 is a view showing a receiving strength distribution chart within a horizontal plane of the antenna of the monitoring unit according to one embodiment of the present invention;

FIG. 10 is a view showing a receiving strength distribution chart within a horizontal plane of the antenna of the monitoring unit according to one embodiment of the present invention;

FIG. 11 is a view describing a shape of a loop antenna of the sensor device according to one embodiment of the present invention;

FIG. 12 is a view describing a horizontal polarization radiation pattern of the loop antenna of the sensor device according to one embodiment of the present invention;

FIG. 13 is a view describing a horizontal polarization radiation pattern of the loop antenna of the sensor device according to one embodiment of the present invention;

FIG. 14 is a view describing a horizontal polarization radiation pattern of the loop antenna of the sensor device according to one embodiment of the present invention;

FIG. 15 is a view describing a vertical polarization radiation pattern of the loop antenna of the sensor device according to one embodiment of the present invention;

FIG. 16 is a view describing a vertical polarization radiation pattern of the loop antenna of the sensor device according to one embodiment of the present invention;

FIG. 17 is a view describing a vertical polarization radiation pattern of the loop antenna of the sensor device according to one embodiment of the present invention;

FIG. 18 is a view describing a position of the sensor device relative to tire rotation according to one embodiment of the present invention;

FIG. 19 is a view describing a radiation pattern of the sensor device mounted on a left rear wheel according to one embodiment of the present invention;

FIG. 20 is a view showing an electric wave transmitted to the antenna from the sensor device mounted on a right front tire according to one embodiment of the present invention;

FIG. 21 is a view showing received electric field strength of electric waves transmitted from the sensor device mounted on a right front tire according to one embodiment of the present invention;

FIG. 22 is a view showing an electric wave transmitted to the antenna from the sensor device mounted on a right rear tire according to one embodiment of the present invention;

FIG. 23 is a view showing received electric field strength of electric waves transmitted from the sensor device mounted on a right rear tire according to one embodiment of the present invention;

FIG. 24 is a view showing an electric wave transmitted to the antenna from the sensor device mounted on a left front tire according to one embodiment of the present invention;

FIG. 25 is a view showing received electric field strength of electric waves transmitted from the sensor device mounted on a left front tire according to one embodiment of the present invention;

FIG. 26 is a view showing an electric wave transmitted to the antenna from the sensor device mounted on a left rear tire according to one embodiment of the present invention;

FIG. 27 is a view showing received electric field strength of electric waves transmitted from the sensor device mounted on a left rear tire according to one embodiment of the present invention;

FIG. 28 is a view showing another embodiment of an antenna installation position according to the present invention;

FIG. 29 is a configuration view showing a conventional type of tire condition monitoring system; and

FIG. 30 is a configuration view showing another conventional type of tire condition monitoring system.

### DETAILED DESCRIPTION OF THE INVENTION

The present invention will now be described in detail with reference to the drawings showing preferred embodiments thereof.

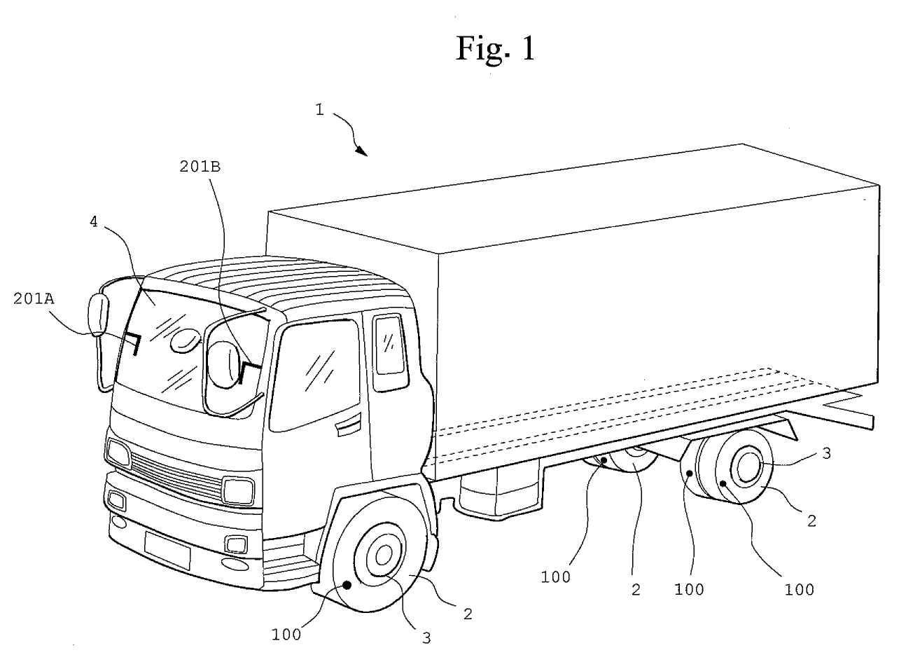

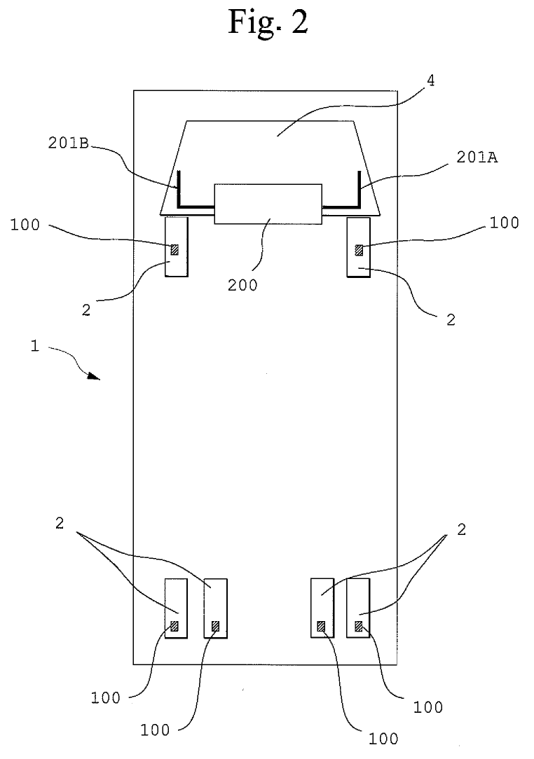

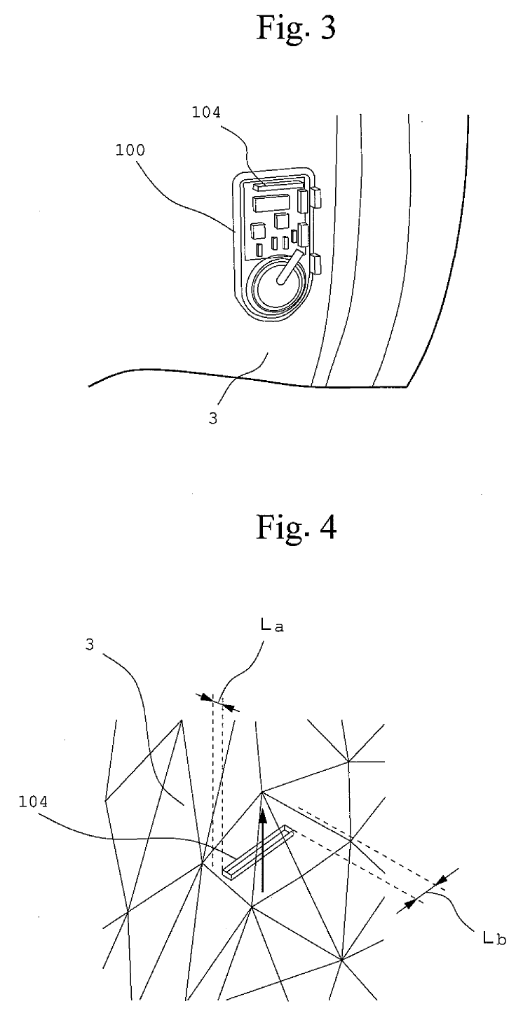

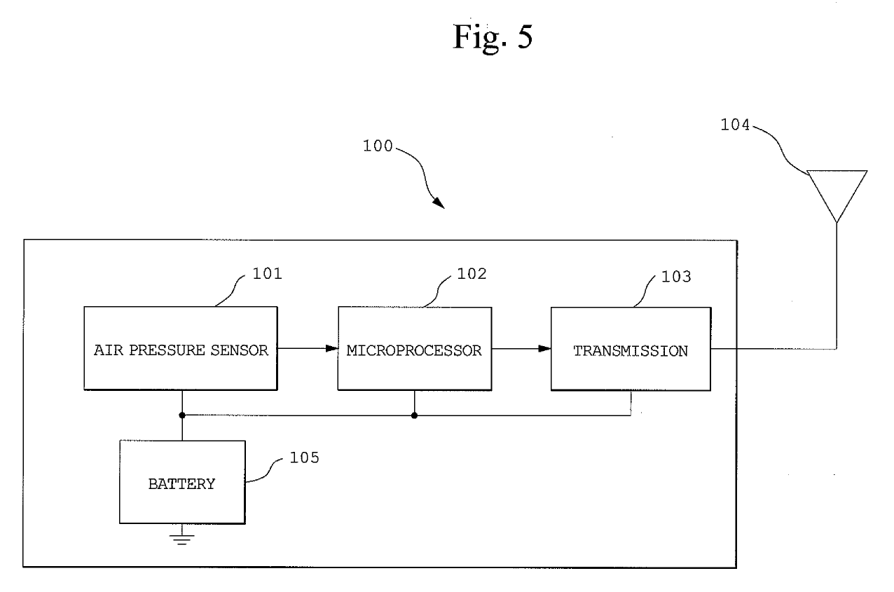

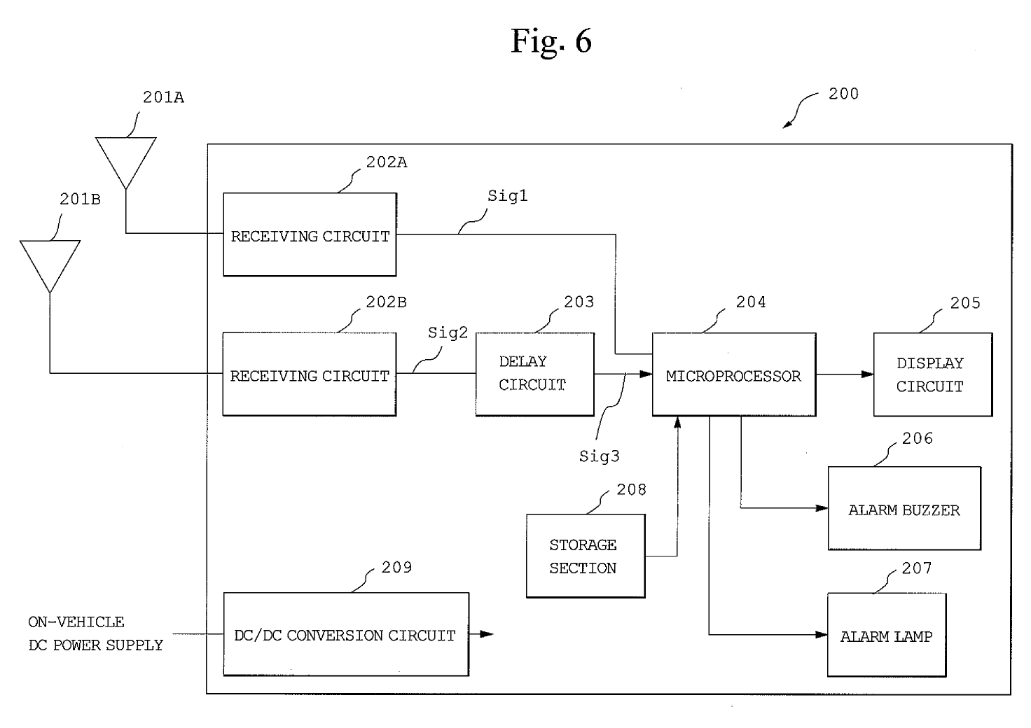

FIGS. 1 to 14 show one embodiment of the present invention. FIG. 1 is an external perspective view showing a vehicle equipped with a tire condition monitoring system according to one embodiment of the present invention, FIG. 2 is a horizontal view showing the tire condition monitoring system illustrated in FIG. 1, and FIG. 3 is a view showing a mounting state of a sensor device. FIG. 4 is a view describing a positional relationship between a loop antenna of the sensor device and a tire wheel, FIG. 5 is a block diagram showing an electric circuit of the sensor device, and FIG. 6 is a block diagram showing an electric circuit of a monitoring unit. FIG, 7 is a timing chart describing operation of a delay circuit, FIG. 8 is a configuration view showing an antenna of the monitoring unit, and FIGS. 9 and 10 are views showing a receiving strength distribution chart within a horizontal plane of the antenna of the monitoring unit, respectively.

Referring first to FIGS. 1 and 2, the configuration of the tire condition monitoring system will be described below. In this description, the front side, rear side, right side and left side when viewed from a driver's seat (not shown) in FIG. 1 are designated as front, rear, right and left, respectively.

A vehicle 1 is, for example, a middle-sized vehicle of 6-wheel type, which has two right and left tires 2 as front wheels and four right and left tires 2 as rear wheels. As shown in FIG. 3, a wheel 3 of each of the tires 2 is mounted with a sensor device 100 which detects a condition of the tire 2, for example, an air pressure in the tire 2 and transmits the detection result by an electric wave.

A loop antenna for transmitting electric waves is built in a casing of the sensor device 100. As shown in FIG. 4, a center shaft of the loop antenna 104 is parallel to a circumferential tangential line of a rim of the wheel 3, and distances La and Lb between a rim surface and the loop antenna 104 are set at 5 mm, respectively.

The sensor device 100, as shown in FIG. 5, is composed of an air pressure sensor 101, a microprocessor 102, a transmission circuit 103, an antenna 104 and a battery 105.

The air pressure sensor 101 is composed of: one sensor element (not shown) which detects an air pressure in the tire 2 and outputs the air pressure as an electric signal; an interface section (not shown) which outputs information corresponding to the air pressure to the microprocessor 102 on the basis of an electric signal output from the sensor element. This embodiment uses the sensor device 100 having only the air pressure sensor 101, however, may use a sensor device having a sensor for detecting the physical quantity of a tire except air pressure, for example, temperature, humidity, vibration and acceleration.

The microprocessor 102 is mainly constituted of a known CPU and includes a memory storing a program for operating the CPU and a calculating memory. The microprocessor 102 inputs information of air pressures in a tire from the air pressure sensor 101 for each 60 seconds, converts the air pressure information into digital signals of a predetermined format including self identification numbers and outputs the digital signals into the transmission circuit 103 as detection results.

The transmission circuit 103 transmits the digital signals input from the microprocessor 102 from the antenna 104 by an electric wave of a predetermined frequency, for example, 315 MHz.

The battery 105 supplies driving power to each of the air pressure sensor 101, the microprocessor 102 and the transmission circuit 103.

Near a driver's seat (no shown), there is installed a monitoring unit 200 which receives electric waves transmitted from the sensor device 100 and displays detection results on a display panel of a display circuit. Moreover, antennas 201A, 201B connected to the monitoring unit 200 through a coaxial cable (not shown) are attached onto both right and left side ends of a windshield 4 on the front of the vehicle 1.

The monitoring unit 200, as shown in FIG. 2, is installed near a driver's seat of the vehicle 1 and includes the antennas 201A, 201B attached onto both right and left side ends of the windshield 4.

The monitoring unit 200, as shown in FIG. 5, is composed of the antennas 201A, 201B, receiving circuits 202A, 202B, a delay circuit 203, a microprocessor 204, a display circuit 205, an alarm buzzer 206, an alarm lamp 207, a storage section 208 and a DC/DC conversion circuit 209.

The antennas 201A, 201B are attached onto both right and left side ends of the windshield 4 as described later.

The receiving circuit 202A receives electric waves transmitted from the sensor device 100 through the antenna 201A, reproduces tire air pressure information and identification information of the sensor device 100 as digital signals and outputs the digital signals into the microprocessor 204.

The receiving circuit 202B receives electric waves transmitted from the sensor device 100 through the antenna 201B, reproduces tire air pressure information and identification information of the sensor device 100 as digital signals and outputs the digital signals into the microprocessor 204 through the delay circuit 203.

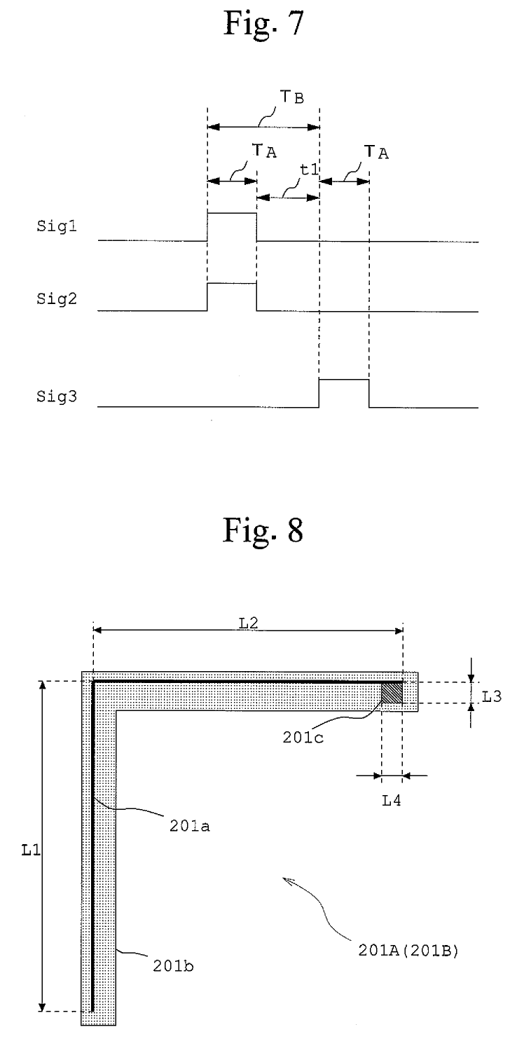

The delay circuit 203, as shown in FIG. 7, inputs a signal Sig2 output from the receiving circuit 202B, delays the signal by a predetermined time TB and outputs the delayed signal Sig3 into the microprocessor 204. The delay time TB is expressed by a formula TB=TA+t1, where TA is a time from the start to the end of a signal output from the receiving circuit 202B, or data transmission time of approx. 5 to 100 ms, depending upon data volume. t1 is a time determined on the basis of reaction performance of a demodulator circuit. Accordingly, when signals are input into the receiving circuits 202A and 202B through the antennas 201A, 201B at the same time, an output signal Sig2 from the receiving circuit 202B is delayed by a delay time TB than an output signal Sig1 from the receiving circuit 202A and is input into the microprocessor 204.

The microprocessor 204 inputs signals Sig1 and Sig3 from the receiving circuit 202A and the delay circuit 203, detects air pressure information and identification information on the basis of the signals, compares the detection result with identification information corresponding to mounting positions of tires stored in a storage section 208, determines which internal tire air pressure the information is about and, if the air pressure is under its allowable range, displays a letter of “low air pressure” and tire position information on the display circuit 205, sounds the alarm buzzer 206 and lights the alarm lamp 207 to annunciate generation of low tire air pressure.

The storage section 208 stores identification information corresponding to mounting positions of tires and information of allowable air pressure range.

The antenna 201A, 201B are both a λ/4 monopole antenna attached onto the surfaces of both right and left ends of the windshield 4 on the front of the vehicle 1, as shown in FIG. 1.

As shown in FIG. 8, the antennas 201A, 201B is composed of a conductor 201a printed on a transparent film 201b, such as polyimide film and a feeding point 201c. The conductor 201a is bent to a right angle and a total of two sides thereof, L1+L2 is set to a length of ¼ an effective wavelength corresponding to a frequency of an electric wave transmitted from the sensor device 100. The feeding point 201c is a metallic piece with a size of L3 long and L4 wide.

Because the dielectric constants of the windshield 4 and the film 201b are higher than that of air, a total of two sides of each of the antennas 201A, 201B, L1+L2 can become shorter than an antenna in the air by approx. 30% and a distance from a window frame portion can be set to a distance within a regulatory limit of the windshield 4. The antennas 201A, 201B are not restricted by the monopole antenna.

In this embodiment, for a transmission frequency 315 MHz of the sensor device 100, for example, L1, L2, L3 and L4 are set at 80 mm, 75 mm, 5 mm and 5 mm, respectively. The dimension of the film 201b is no object.

A shield wire of a coaxial cable for connecting the antennas 201A, 201B with the monitoring unit 200 is conductive-connected with a metal at a vehicle window frame.

One side of each of the antennas 201A, 201B is adhesively attached onto the windshield 4 so as to extend in the vertical direction, by which the receiving strength within the horizontal plane are almost uniform regardless of any angle within the horizontal plane, as shown in FIGS. 9 and 10. FIG. 9 shows the receiving strength of the right antenna 201A and FIG. 10 shows the receiving strength of the left antenna 201B. An increase in receiving strength at 0 to 90 degrees as compared to that at other angles, as found in FIG. 9, is supposed to result from the antenna 201A attached onto the right side of the windshield 4 of the vehicle 1. On the other hand, an increase in receiving strength at 270 to 0 degree (360 degrees) as compared to that at other angles, as found in FIG. 10, is supposed to result from the antenna 201B attached onto the left side of the windshield 4 of the vehicle 1.

Generally, receiving by the λ monopole antenna increases a value of receiving strength, and miniaturizing the monopole antenna decreases receiving strength. In this embodiment, the λ/4 monopole antenna is bent to a right angle to achieve miniaturization as well as realization of ideal receiving strength next to that of the λ monopole antenna with maximum electric wave intensity of approx. −1.9 dB.

Moreover, use of the transparent film 201b constituting the antennas 201A, 201B will not obstruct a driver's view even if the film is attached onto the windshield 4 of the vehicle 1, nor degrade the appearance of the vehicle 1.

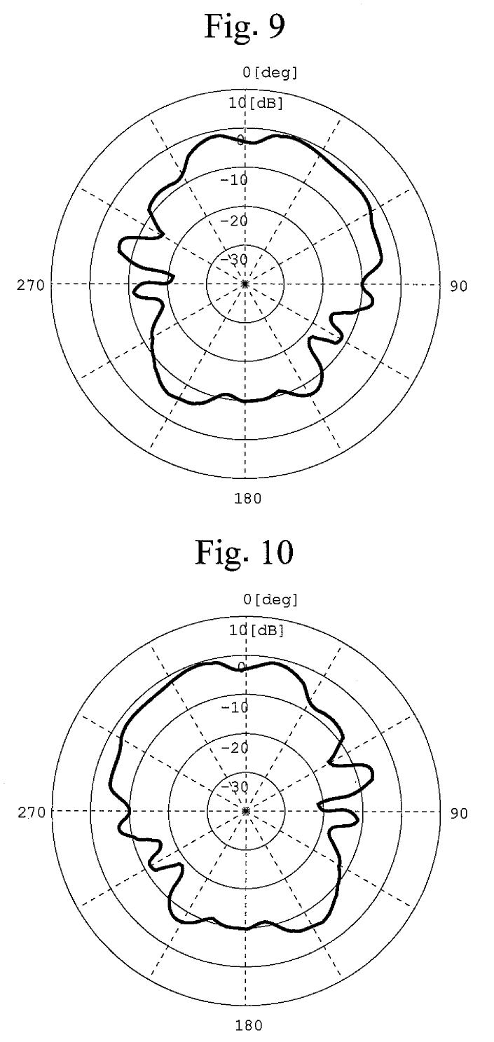

FIGS. 11 to 17 describe simulation results of radiation patterns of the loop antenna 104 in the sensor device 100. FIG. 11 describes a shape of the loop antenna, and the loop antenna 104 is constructed by winding a copper wire. The loop antenna 104 has 20 mm in width W1, 2 mm in thickness D1 and 1.5 mm in height H1. The origin of X-, Y- and Z-axis orthogonal to each other in FIG. 11 is taken as a feeding point 104a of the antenna 104.

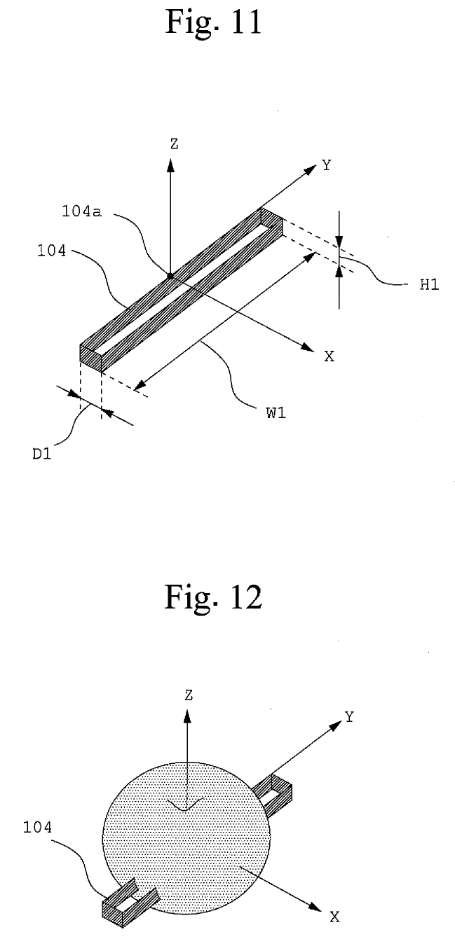

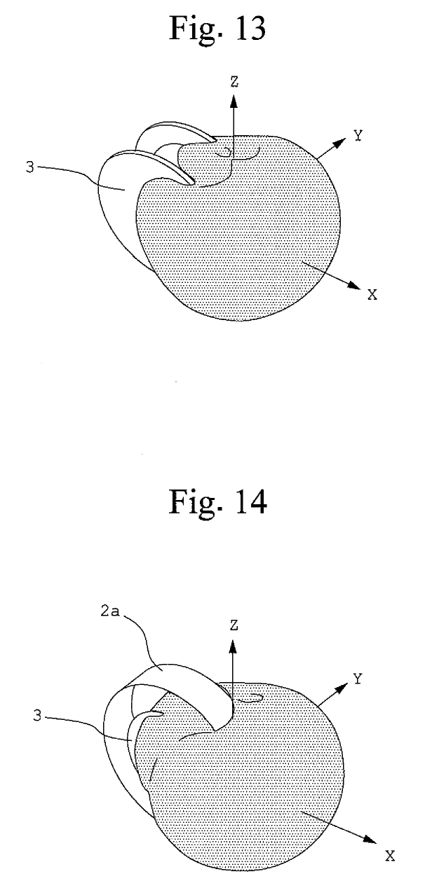

FIGS. 12 to 14 show a state of horizontal polarization, respectively. FIG. 12 shows a polarization state in the case of the single sensor device 100, FIG. 13 a polarization state when the sensor device 100 is mounted onto the wheel 3, and FIG. 14 a polarization state when the sensor device 100 is mounted on the tire 2, respectively. Reference character 2a in FIG. 14 denotes a belt in the tire 2.

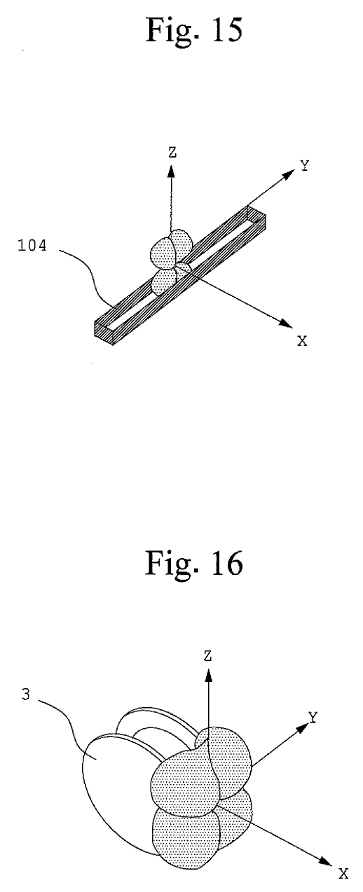

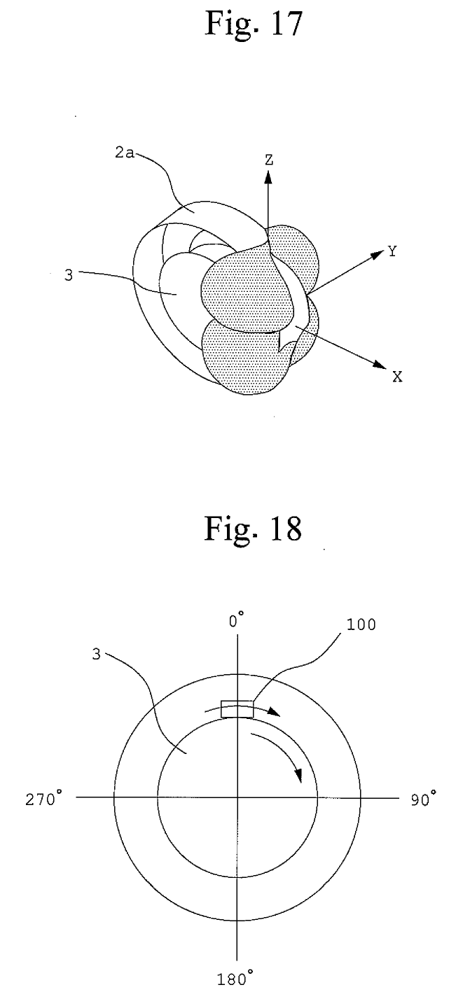

FIGS. 15 to 17 show a state of vertical polarization, respectively. FIG. 15 shows a polarization state in the case of the single sensor device 100, FIG. 16 a polarization state when the sensor device 100 is mounted onto the wheel 3, and FIG. 17 a polarization state when the sensor device 100 is mounted on the tire 2, respectively. Reference character 2a in FIG. 17 denotes a belt in the tire 2.

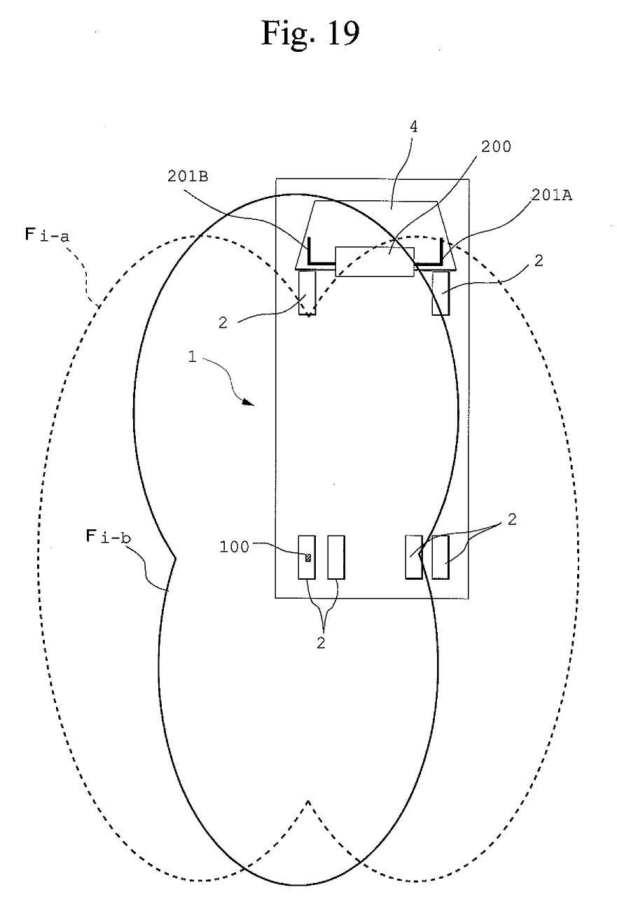

The antenna 104 of the sensor device 100 has such a polarization state as described above. Accordingly, as shown in FIG. 18, when the tire 2 rotates, for example, in the case of the sensor device 100 mounted on a left rear wheel, a simulation result shown in FIG. 19 indicates that when the sensor device 100 depends upon a position of 0 or 180 degrees, a radiation pattern Fi-a indicated by dashed lines is obtained and receiving by the left antenna 201B is difficult, however, positive receiving can be achieved by the right antenna 201A. On the other hand, when the sensor device 100 depends upon a position of 90 or 270 degrees, the simulation results indicates a radiation pattern Fi-b indicated by solid lines is obtained and receiving by the right antenna 201A is difficult, however, positive receiving can be achieved by the left antenna 201B.

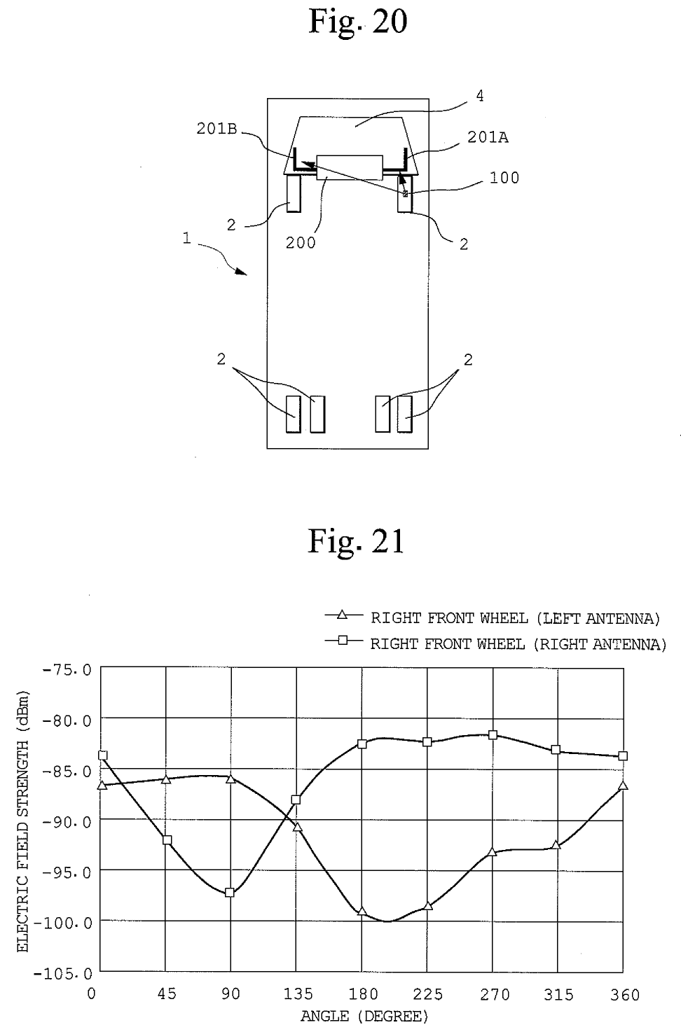

FIGS. 20 to 27 describe actual measurements of electric field strength during receiving, by the respective antennas 201A, 201B, of electric waves transmitted from the sensor device 100 mounted on each of front and rear tires.

FIG. 21 shows electric field strength during receiving, by the respective antennas 201A, 201B, of electric waves transmitted from the sensor device 100 mounted on a right front tire 2 as shown in FIG. 20. When rotational angles of tires are 0, 45, 90, 135, 180, 225, 270, 315 and 360 degrees as shown in FIG. 21, electric field strengths received by the right antenna 201A are −87.0 dBm, −86.5 dBm, −86.0 dBm, −91.0 dBm, −98.0 dBm, −97.5 dB, −93.0 dBm, −92.5 dBm and −87.0 dBm, respectively. On the other hand, electric field strengths received by the left antenna 201B are −84.0 dBm, −92.0 dBm, −97.0 dBm, −88.0 dBm, −83.0 dBm, −82.5 dB, −82.0 dBm, −83.0 dBm and −84.0 dBm, respectively. When one received electric field strength of the antennas 201A, 201B is low like this, the other received electric field strength becomes high. On the other hand, when the other received electric field strength is low, one received electric field strength becomes high, that is, such a characteristic as to compensate for each other is obtained.

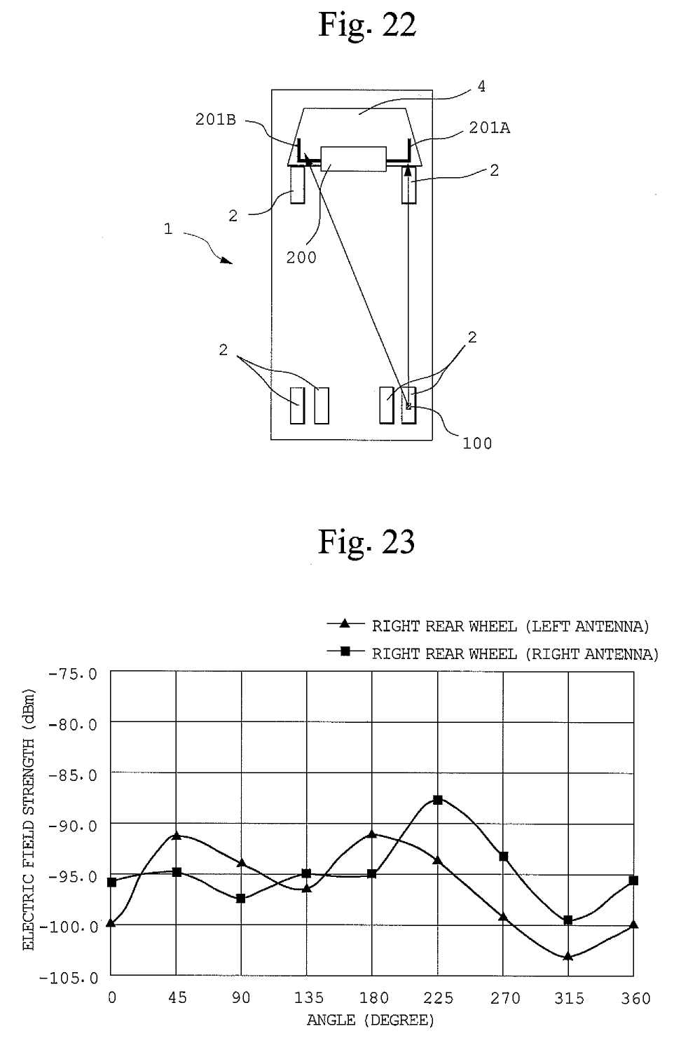

FIG. 23 shows electric field strength during receiving, by the respective antennas 201A, 201B, of electric waves transmitted from the sensor device 100 mounted on a right rear tire 2 as shown in FIG. 22. When rotational angles of tires are 0, 45, 90, 135, 180, 225, 270, 315 and 360 degrees as shown in FIG. 23, electric field strengths received by the right antenna 201A are −96.0 dBm, −95.0 dBm, −97.5 dBm, −95.0 dBm, −95.0 dBm, −87.5 dBm, −93.0 dB, −99.0 dBm, and −96.0 dBm, respectively. On the other hand, electric field strengths received by the left antenna 201B are −100.0 dBm, −92.0 dBm, −93.5 dBm, −96.5 dBm, −92.0 dBm, −93.0 dB, −99.0 dBm, −103.0 dBm and −100.0 dBm, respectively. When one received electric field strength of the antennas 201A, 201B is low like this, the other received electric field strength becomes high. On the other hand, when the other received electric field strength is low, one received electric field strength becomes high, that is, such a characteristic as to compensate for each other is obtained.

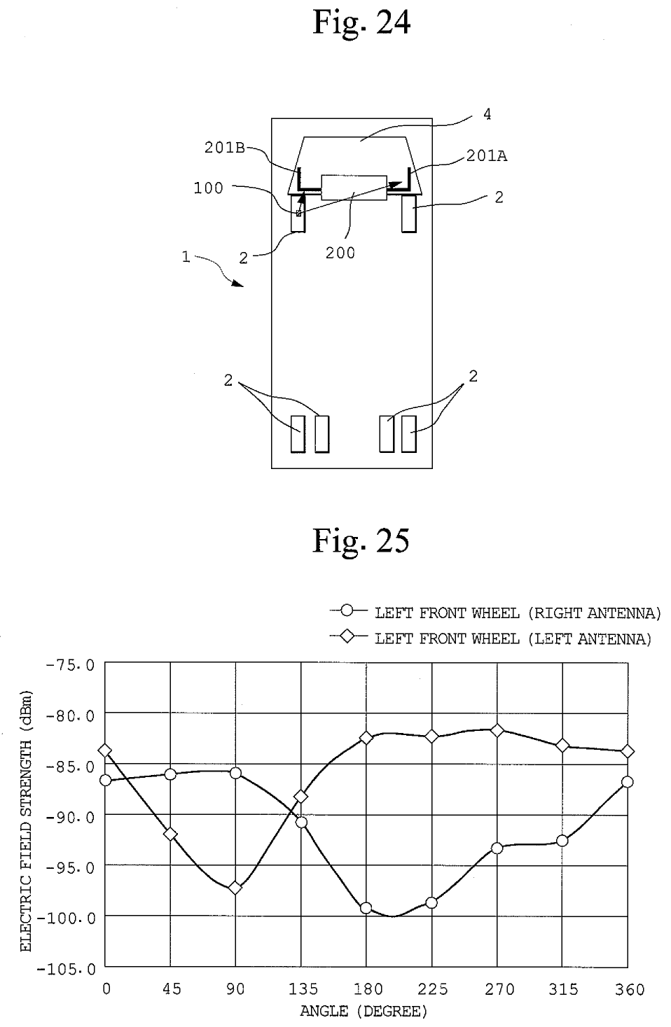

FIG. 25 shows electric field strength during receiving, by the respective antennas 201A, 201B, of electric waves transmitted from the sensor device 100 mounted on a left front tire 2 as shown in FIG. 24. When rotational angles of tires are 0, 45, 90, 135, 180, 225, 270, 315 and 360 degrees as shown in FIG. 25, electric field strengths received by the right antenna 201A are −84.0 dBm, −92.0 dBm, −97.0 dBm, −88.0 dBm, −83.0 dBm, −82.5 dB, −82.0 dBm, −83.0 dBm and −84.0 dBm, respectively. On the other hand, electric field strengths received by the left antenna 201B are −87.0 dBm, −86.5 dBm, −86.0 dBm, −91.0 dBm, −98.0 dBm, −97.5 dB, −93.0 dBm, −92.5 dBm and −87.0 dBm, respectively. When one received electric field strength of the antennas 201A, 201B is low like this, the other received electric field strength becomes high. On the other hand, when the other received electric field strength is low, one received electric field strength becomes high, that is, such a characteristic as to compensate for each other is obtained.

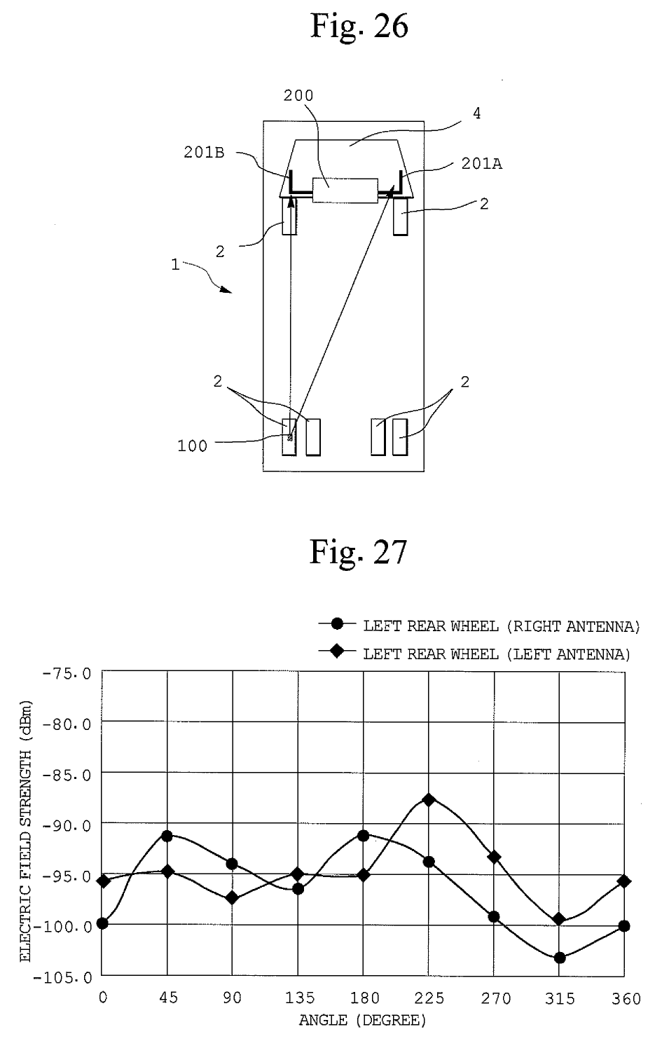

FIG. 27 shows electric field strength during receiving, by the respective antennas 201A, 201B, of electric waves transmitted from the sensor device 100 mounted on a left rear tire 2 as shown in FIG. 26. When rotational angles of tires are 0, 45, 90, 135, 180, 225, 270, 315 and 360 degrees as shown in FIG. 27, electric field strengths received by the right antenna 201A are −100.0 dBm, −92.0 dBm, −93.5 dBm, −96.5 dBm, −92.0 dBm, −93.0 dB, −99.0 dBm, −103.0 dBm and 100.0 dBm, respectively. On the other hand, electric field strengths received by the left antenna 201B are −96.0 dBm, −95.0 dBm, −97.5 dBm, −95.0 dBm, −95.0 dBm, −87.5 dB, −93.0 dBm, −99.0 dBm and −96.0 dBm, respectively. When one received electric field strength of the antennas 201A, 201B is low like this, the other received electric field strength becomes high. On the other hand, when the other received electric field strength is low, one received electric field strength becomes high, that is, such a characteristic as to compensate for each other is obtained.

As described above, the tire condition monitoring system in this embodiment provides elimination of need of attaching a receiving antenna of the monitoring unit 200 at a position corresponding to the sensor device 100 of each of the tires 2 as well as easy installation of the monitoring unit 200 only by attaching the antennas 201A, 201B onto the windshield 4. This enables reductions in time, effort and cost more than in conventional examples and high receiving probability with the monitoring unit 200 because there is indicated such a characteristic that the received electric field strength of one antenna 201A and that of the other antenna 201B compensate for each other.

The configuration in this embodiment is one of preferred examples of the present invention, but is not limited to such an configuration. Moreover, this embodiment describes an application of the tire condition monitoring system according to the present invention to middle-sized vehicles, but it goes without saying that an application to large-sized vehicles yields the same effect.

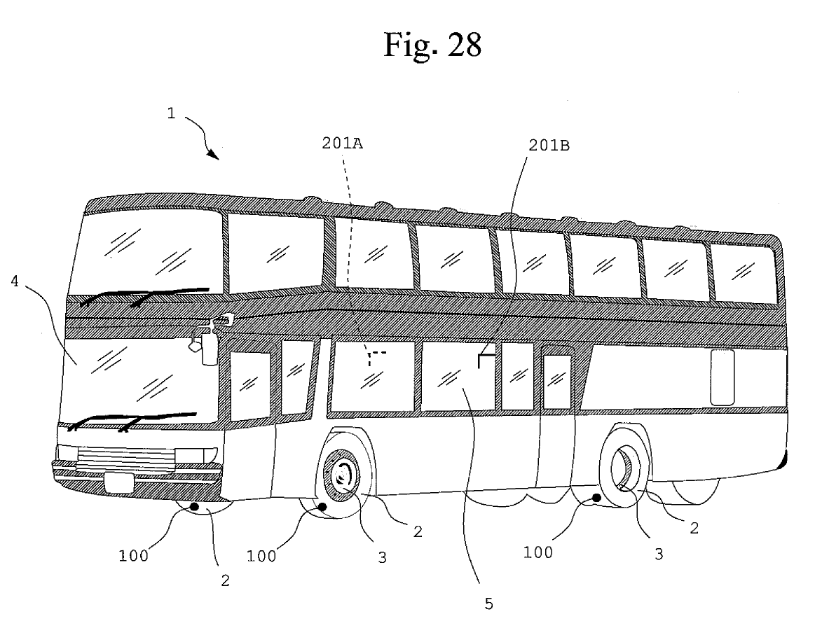

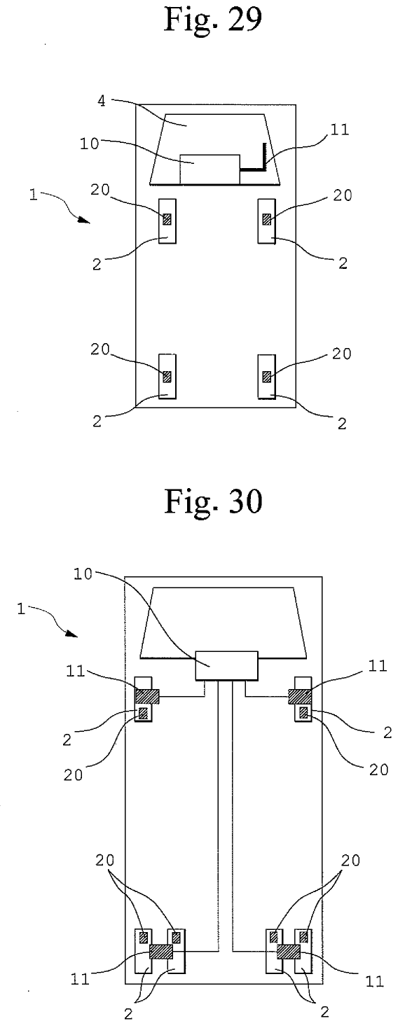

In addition, as shown in FIG. 28, in applying the tire condition monitoring system according to the present invention to bus vehicles 1, it is preferable to attach the antennas 201A, 201B onto right and left side window glass 5. This enables higher receiving probability. Furthermore, in the case of a vehicle with a long overall length, such as a bus, preferably, the antennas 201A, 201B are attached at the midpoint of front and rear tires 2 for high receiving probability.

What is claimed is:

1. A tire condition monitoring system, comprising a plurality of sensor devices, at least one being mounted on each of all tires of a vehicle, each having a sensor detecting the physical quantity of the tire and transmitting detection results from the sensor to the outside of the tire by an electric wave and a monitoring unit receiving electric waves from the plurality of sensor devices and acquiring the detection results from the sensor for each of the sensor devices, the tire condition monitoring system comprising:
an antenna disposed on each window glass of right and left side portions of the vehicle, connected to the monitoring unit and receiving electric waves transmitted from the respective sensor devices, wherein
the monitoring unit comprises:
a plurality of receiving sections disposed for each antenna;
a central processing unit which inputs received signals output from each of the plurality of receiving sections and acquires detection results from the received signals for each of the sensor devices; and
at least one delay section which delays, on the basis of received signals output from a predetermined one receiving section, output signals from the other receiving sections by different periods, respectively and inputs the signals into the central processing unit.

2. The tire condition monitoring system according to claim 1, wherein the antenna is attached onto each of the right and left side edges of a windshield of the vehicle.

3. The tire condition monitoring system according to claim 1, wherein the antenna is attached onto any window glass of the vehicle.

4. The tire condition monitoring system according to claim 3, wherein the antenna is disposed so as to be positioned at the midpoint of front and rear tires on the right or left of the vehicle.

5. The tire condition monitoring system according to claim 1, wherein the detection results includes at least one of air pressure, temperature, humidity, vibration and acceleration.
